(19) United States
(12) Patent Application Publication
(10) Pub. No.: US 2004/0103761 A1
(43) Pub. Date: Jun. 3, 2004

(54) Fixed angle extension for a tool

(76) Inventor: Thomas M. Pillow, Springfield, VA (US)

Correspondence Address: REED SMITH LLP, Suite 1400, 3110 Fairview Park Drive, Falls Church, VA, 22042, US

(21) Appl. No.: 10/684,512

(22) Filed: Oct. 15, 2003

Related U.S. Application Data
(60) Provisional application No. 60/418,230, filed on Oct. 15, 2002.

(51) Int. Cl. B25B 21/00

(52) U.S. Cl. 81/57.12

(57) ABSTRACT

An extension to be releasably engaged with a driving tool and a driven tool, includes two tubular housings each for accommodating a beveled gear, a shaft intersecting via the beveled gear and having a shaft end at one end thereof for engaging with one of the driving tool and the driven tool, and a pair of supporting bearings for rotatively supporting the shaft in first housing; an internal end thread in one of the housings and a threaded locking ring at a side of the other of the housing being releasably engaged in a L-shape or T-shape. One beveled gear is positioned at another end of the respective shaft to rotatively engage at a non-zero and non-180-degree angle with another beveled gear positioned in the medium section of or at another end of the respective shaft.

This application claims the benefit of U.S. Provisional Patent Applications Serial No. 60/418,230 filed on Oct. 15, 2002, the entire disclosures of which are incorporated herein by reference.

### BACKGROUND OF THE INVENTION

1. Field of the Invention

The present invention relates in general to a fixed angle tool extension for use with manual or pneumatic ratchets, impact guns, or the like, so as to position the ratchet or the impact gun at an angle relative to the fastener being tightened or loosened. The present invention includes two shafts supported by bearings that intersect with interlocking beveled gears enclosed in a housing so as to change the rotation axis of the ratchet or the impact gun at the angle different from the rotation axis of a driven tool.

2. Description of Related Arts

Existing tool extensions are not satisfactory because these extensions or tool connectors do not change the direction of a rotation axis of the driven tool at one end to be different form the direction of a rotation axis of the driving tool. U.S. Pat. No. 6,553,628 describes a paint roller assembly including a handle that is configured for use with a variety of extension poles, each requiring a different type of connection with the handle. The handle includes a pole connector socket extending inwardly from one end thereof that is designed to receive a number of different pole connectors. However, the illustrated pole connector only connects the handle with an extension pole in a straight line, rather than other fixed angles, such as a 30, 45, or 90 degrees.

U.S. Pat. No. 6,532,630 describes an extension pole providing a flush connection between a handle and a paint roller tool to prevent relative rotation therebetween. Although the paint roller tool turns at 90 degrees, the extension pole only connects the handle with the paint roller tool in a straight line, rather than other non-180-degree fixed angles, such as 30, 45, or 90 degrees angle.

U.S. Pat. No. 6,389,931 describes an extension 10 between a driving tool 26 and a driven member 28 which has a hollow body with external gear teeth on one end which is releasably retained in the driving tool 26. It is the driving tool 26 engaged with the extension 10 at a 90-degree angle, rather than the extension itself providing an additional angle as needed.

U.S. Pat. No. D459,959 shows an extension arm tool for unloading sizeable objects from a pickup truck bed. The 90-degree angled arm is a tool rather than a tool connector since it does not receive any other tool or tool head. U.S. Pat. No. D417,383 shows a tool extension assembly which, at most, positions the rotation axis of the tool at a 90-degree angle relative to the T-shaped handle, but not to change the rotation axis of the tool relative to a received member.

U.S. Pat. No. 5,732,605 describes a wrench extension tool having a gear train of intermeshing idler gears contained within an inner housing formed of two curved and substantially parallel plates. Aligned pairs of bores are provided through the parallel plates providing residence for axle pins about which the idler gears rotate. At each end of the wrench extension tool is a socket opening in which there resides an end gear. A relatively narrow wrench extension is provided where with a drive end and a driven end. The wrench extension maintains one tool inserted into the drive end and another tool inserted into the driven end in parallel, i.e., their rotation axes are either 0 or 180 degree apart, rather than any non-180-degree fixed angles, such as a 30, 45, or 90 degrees angle.

U.S. Pat. No. 4,913,007 describes a right angle extension tool for interconnection with a socket wrench. The tool includes an elongated cylinder with a shaft disposed therein. The shaft has a socket box connected to a first end for interconnection with a socket wrench, and has a right angle drive mechanism on a second end. A socket pin is connected to a shaft extending from the right angle drive mechanism. In particular, the shaft includes one or more mechanisms, such as articulated joints, to permit the extension tool to flex so difficult to reach bolts or the like can be removed or tightened. It is not satisfactory because the “universal” extension or tool connector flexes and binds when a shaft therein being rotated.

The prior art references do not show or teach a tool extension changing the direction of a rotation axis of a driven tool to be different from the direction of the rotation axis of a driving tool without being flex and bind when two shafts therein being rotated. There is therefore a need in the art for a fixed angle tool extension to provide access to an area to be reached via an angle without being flex and bind when two shafts therein being rotated.

### SUMMARY OF THE INVENTION

It is a purpose of this invention to provide a portable fixed angle tool extension for use with manual or pneumatic ratchets, impact guns, or the like.

It is another purpose of this invention to eliminate the problems of flexing and bending of the existing universal extensions or tool connectors thereby reducing wearing on the bearings, shafts and gears in the extensions.

It is another purpose of this invention to eliminate the problems of flexing and bending of the existing universal extensions or tool connectors thereby stabilizing the engagement with the driving tool and driven tool and preventing slipping off the extension which may cause injury or damage.

It is still another purpose of this invention to provide an easy-to-use and ease-to-repair tool extension.

In accordance with the teachings of the present invention, there is disclosed an extension to be releasably engaged with a driving tool and a driven tool, including two tubular housings each for accommodating a beveled gear, a shaft intersecting via the beveled gear and having a shaft end at one end thereof for engaging with one of the driving tool and the driven tool, and a pair of supporting bearings for rotatively supporting the shaft in first housing; an internal end thread in one of the housings and a threaded locking ring at a side of the other of the housing being releasably engaged in a L-shape or T-shape. One beveled gear is positioned at another end of the respective shaft to rotatively engage at a non-zero and non-180-degree angle with another beveled gear positioned in the medium section of or at another end of the respective shaft.

These and other objects of the present invention will become apparent from a reading of the following specification taken in conjunction with the enclosed drawings.

### BRIEF DESCRIPTION OF THE DRAWINGS

The foregoing features and advantages of the invention will become apparent from the following more particular description of preferred embodiments of the invention, as illustrated in the accompanying drawings, in which:

FIG. 1 is a perspective view of an embodiment of the invention.

FIG. 2 is a side view of the embodiment in FIG. 1 when the first housing and the second housing are not threadedly engaged.

FIG. 3 is an exploded side view of embodiment in FIG. 1.

FIG. 4 are side views of other embodiments of the invention when the first housing and the second housing are threadedly engaged at 30, 45, and 60 degrees angles respectively.

FIG. 5 are side views of different embodiments of interchangeable ends of the embodiment in FIG. 1.

### DESCRIPTION OF THE PREFERRED EMBODIMENT

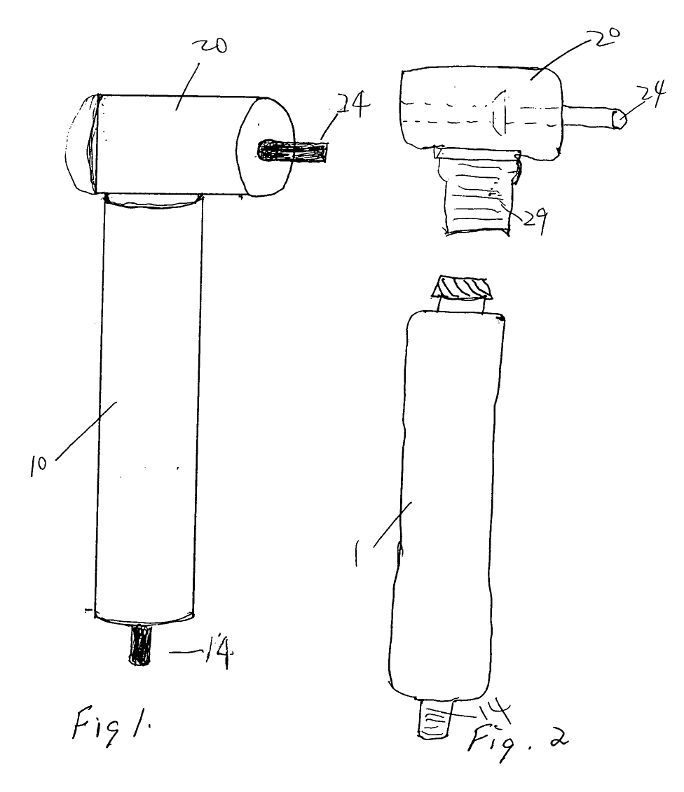

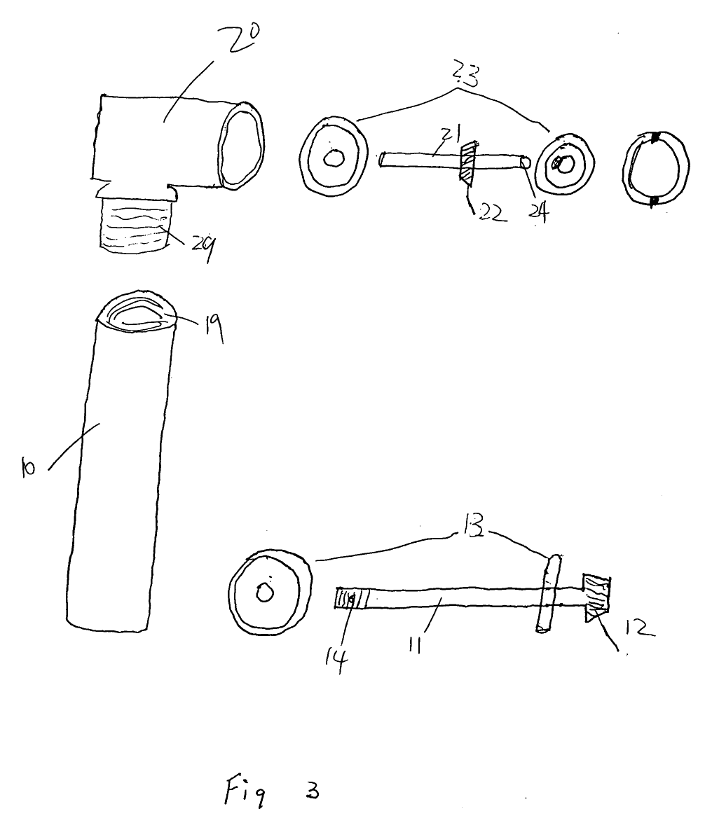

FIG. 1 shows a fixed angle tool extension 1 between a driving tool 2 (not shown) and a driven tool 3 (not shown). The driving tool can be any manual or pneumatic ratchets, impact guns, or the like. The driven tool can be any means to be driven, such as a screw. The fixed angle tool extension 1 includes a first cylindrical housing 10 and the second cylindrical housing 20 which is threadedly engaged in a T-shape or a L-shape by an internal end thread 19 of the first cylindrical housing 10 and a threaded locking ring 29 of the second cylindrical housing 20. Alternatively, the first cylindrical housing 10 has a threaded locking ring and the second cylindrical housing 20 has an internal end thread. The threaded locking ring is preferably attached to a shorter housing (in this case, the second cylindrical housing 20) to provide additional support thereto. FIG. 2 is a side view of the embodiment in FIG. 1 when the first housing 10 and the second housing 20 are not threadedly engaged.

As shown in FIG. 3, each housing has a beveled gear 12 or 22, a shaft 11 or 21 intersecting via the gear at one end and a shaft end 14 or 24 at the other end, and a pair of supporting bearings 13 or 23 supporting the shaft in the respective cylindrical housing. The bearings 13 or 23 are preferably sealed. The input shaft 11 is preferably longer than then output shaft 21 for better supporting the usually heavier driving tool 2. The beveled gear 12 of the first cylindrical housing 10 is positioned at one end to rotatively engage with the beveled gear 22 of the second cylindrical housing 20. The beveled gear 22 may be position at the end or with the second cylindrical housing 20. The later position is preferred to provide more support and stability during rotation. The designs of the first cylindrical housing 10 and the second cylindrical housing 20 are interchangeable such that the beveled gear 12 may be positioned at one end or within the first cylindrical housing 10 to rotatively engage with the beveled gear 22 positioned at the end of the second cylindrical housing 20. The shaft 22 is locked into place by screwing the housing 20 onto the housing 10. By unscrewing the housing 20 and removing the locking ring 29, all the parts are easily removable for replacement, if necessary. The housings 10, 20 may be shaped as any hollow columns with a cross section of a circular cylinder, an ellipse cylinder, a rectangular column, a polygon column, etc.

The angles and pitches of the gears 12, 22, the shapes of the housings 10, 20, and the angle and pitch of the threaded ring 29 vary, depending on the desired degree of offset between the input shaft 11 and the output shaft 21, i.e., 30, 45, 60, 90 degrees, etc. FIGS. 4-1, 4-2 and 4-3 show the first housing and the second housing being threadedly engaged at 30, 45, and 60 degrees angles respectively. For angle 45, the angle and pitch of the threaded ring 29 are also 45 degree to provide best support, although hard to manufacture. The different embodiments allow rotatively engaging the ratchet or gun 2 at an angle relative to the driven tool 3 being tightened or loosened. Additional straight extensions may be connected to either or both shafts 11, 21 to accommodate any space constraints.

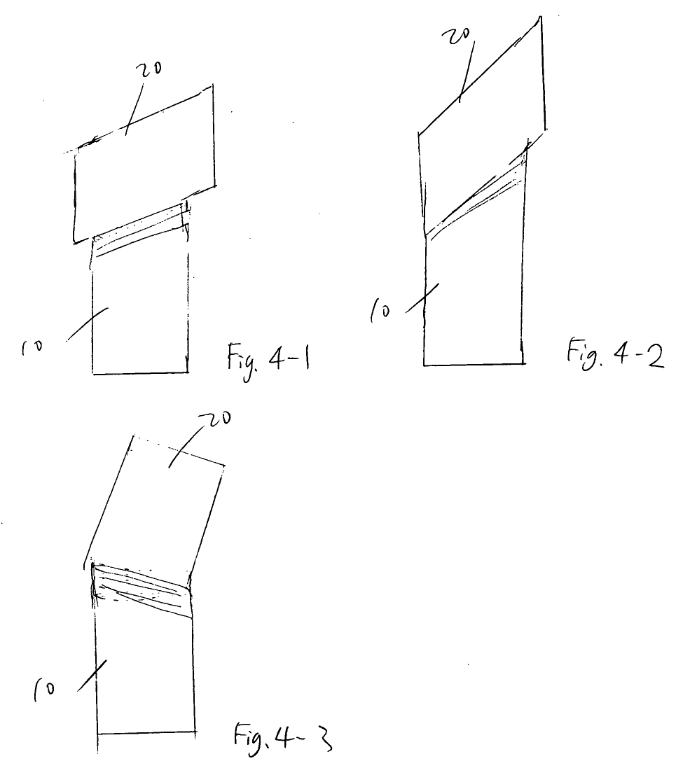

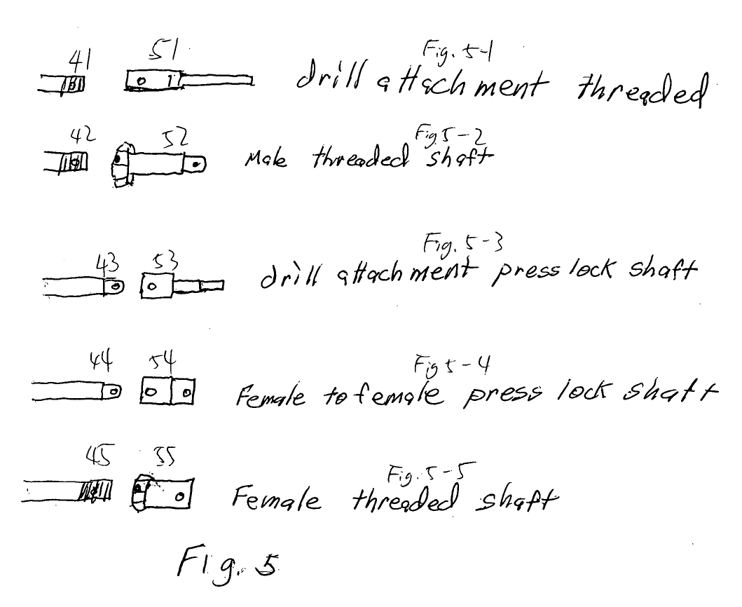

The shaft ends 14, 24 (FIG. 5) could be male or female threaded to inter-changeably engage with the driving tool 2 or the driven tool 3. In FIG. 5-1, a chosen end 41 is screwed onto the shaft to engage with a drill head 51. In FIG. 5-2, a male-threaded end 42 is screwed onto the shaft and a castle nut is secured with a roll pin 52. In FIG. 5-3, the shaft end 43 has a female press lock to engage with a drill head 53 having a male press lock. A spring loaded ball on the male penetrating) press lock snaps into a detent in the female (receiving) press lock. In FIG. 5-4, the shaft end 44 also has a female press lock to engage with a female-to-female adapter 54 having a male press lock. In FIG. 5-5, the shaft end 45 is a female threaded to engage with a female-to-thread adapter 55. The threads provide better support and stability during rotation of the shafts, while the easy removal of the snap ring permits shaft removal for gear and or bearing replacement.

Although the tool extension 1 has been shown with a few different embodiments with several shaft ends, it will be-appreciated that the tool extension 1 may be configured for use with other shaft ends designed to releasably connect with the tool extension 1 in further various manners. The embodiments shown are examples demonstrating the concept of a fixed angle gear driven extension which do not preclude the use of other possible gearing arrangements, i.e., worm gear and wheel, ring and pinion et al. nor limit the invention to one type of gearing. Such shaft ends may simply require slight modification of the shafts and/or the housings disclosed herein.

The materials for different parts of the tool extension vary according to the sizes of the driving tool 2 and the driven tool 3. For example, for working with an impact gun having a ⅜″ diameter head and a ⅜″ diameter drill head, the housings are made of aluminum or steel in the dimensions of 2″ and 5″ long with a 1″ diameter, the beveled gears are made of hardened steel with a ⅜″ diameter via hole, the shafts are made of hardened steel in the dimensions of 5½″ long with a ⅜″ diameter, and the pair of supporting bearings with a ⅜″ diameter via hole.

The principles, preferred embodiments and modes of operation of the present invention have been described in the foregoing specification. However, the invention which is intended to be protected is not limited to the particular embodiments disclosed. The embodiments described herein are illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An extension to be releasably engaged with a driving tool and a driven tool, comprising:
a first tubular housing for accommodating a first beveled gear, a first shaft intersecting via the first beveled gear and having a first shaft end at one end thereof for engaging with one of the driving tool and the driven tool, and a first pair of supporting bearings for rotatively supporting the first shaft in the first housing;
a second tubular housing for accommodating a second beveled gear, a second shaft intersecting via the second beveled gear and having a second shaft end at one end thereof for engaging with the other one of the driving tool and the driven tool, and, a second pair of supporting bearings for rotatively supporting the second shaft in the second housing; and
an internal end thread in one of the housings and a threaded locking ring at a side of the other of the housing being releasably engaged in a L-shape or T-shape,
wherein the first beveled gear is positioned at another end of the first shaft to rotatively engage at a non-zero and non-180-degree angle with the second beveled gear, positioned in the medium section of or at another end of the second shaft.

2. The extension according to claim 1, wherein the second shaft is position in place by screwing the threaded locking ring onto the internal end thread.

3. The extension according to claim 1, wherein the shafts, the gears, and the bearings are easily removable for replacement by unscrewing the threaded locking ring onto the internal end thread

4. The extension according to claim 1, wherein a non-zero and non-180-degree angle is a 30, 45, 60, or 90 degree angle.

5. The extension according to claim 1, wherein the housings are shaped as a circular cylinder, an ellipse cylinder, a rectangular column, or a polygon column.

6. The extension according to claim 1, wherein one of the housings to be engaged with the driving tool is longer than then the other one of the housings to be engaged with the driven tool.

7. The extension according to claim 1, wherein angles and pitches of the gears vary, depending on the non-zero and non-180-degree angle.

8. The extension according to claim 1, wherein shapes of the housings vary, depending on the non-zero and non-180-degree angle.

9. The extension according to claim 1, wherein an angle and a pitch of the threaded ring vary, depending on the non-zero and non-180-degree angle.

10. The extension according to claim 1, wherein shaft ends of the shafts are inter-changeably engage with the driving tool or the driven tool.

11. The extension according to claim 1, wherein shaft ends of the shafts are male or female threaded to engage with the driving tool or the driven tool.

12. The extension according to claim 1, wherein shaft ends of the shafts are male or female press-locks to engage with the driving tool or the driven tool.

13. he extension according to claim 1, wherein at least one straight extension is connected to either or both of the housings to accommodate any space constraints between the extension the driving tool or the driven tool.

14. The extension according to claim 1, wherein the driving tool is a manual or pneumatic ratchet, or an impact gun.

15. The extension according to claim 1, wherein the supporting bearings are sealed.
